(19) United States
(12) Patent Application Publication
(10) Pub. No.: US 2022/0033681 A1
(43) Pub. Date: Feb. 3, 2022

(54) BLASTING ABRASIVES AND METHOD OF PRODUCING BLASTING ABRASIVES

(71) Applicant: Conox, LLC, Spring, TX (US)

(72) Inventor: Scott D. Trom, Spring, TX (US)

(73) Assignee: Conox, LLC, Spring, TX (US)

(21) Appl. No.: 17/351,850

(22) Filed: Jun. 18, 2021

Related U.S. Application Data
(60) Provisional application No. 63/041,262, filed on Jun. 19, 2020.
(60) Provisional application No. 63/147,322, filed on Feb. 9, 2021.

(51) Int. Cl. C09G 1/02; C09K 3/14

(52) U.S. Cl. CPC C09G 1/02; C09K 3/1454; C09K 3/1409

(57) ABSTRACT

Blasting abrasives comprise a plurality of particles. Blasting abrasives are classified into two basic types with many varieties of particles within these categories. Sharp, angular, and blocky abrasives and bead and/or rounded abrasives. Blasting abrasives are describe that are made from mixing particles of sharp, angular or blocky abrasives with bead or round abrasives. The blasting performance of any sharp, angular, or blocky abrasive may be improved by combining it with the bead or round abrasives in concentrations from 0.1 wt. % to 50 wt. %.

### FIELD OF THE INVENTION

The invention is directed toward both dry and wet abrasive blasting abrasives for use in cleaning, preparing surfaces, removing coatings, and other abrasive blasting applications.

Abrasive blasting refers to the process of forcibly propelling a stream of particles or grit against a surface or substrate at high pressure.

Abrasive blasting can be used to efficiently remove corrosion, rust, mill scale, paint, or coatings from a substrate to be restored, painted, or cleaned. In certain applications, a certain degree of surface roughening (called anchor profile) may be desired from abrasive blasting process to enhance the adhesion of subsequently applied paint or other coating.

Embodiments of blasting abrasive and processes may be used in dry blasting or wet abrasive blasting. In dry blasting, the blasting abrasives are forcibly propelled by a stream of air through the blast hose and nozzle onto the surface or substrate. Wet-abrasive systems are designed to force a slurry stream of blasting abrasive and water into a compressed air stream to provide a three-phase blasting spray. In ultra-high pressure water-abrasive blasting a slurry stream of abrasive and water force the compressed stream through a focus tube or nozzle to provide a two-phase blasting spray.

Further, embodiments of the blasting abrasive may be used in water-jet or abrasive jet cutting processes of metals and other materials.

Embodiments of the blasting abrasives described comprise a combination of SAB abrasives and bead or round abrasives. The combination of SAB abrasive and bead abrasive provide a synergistic effect that improves the blasting performance of either the SAB abrasive alone or the bead abrasive alone. Conventional abrasives are compositions of largely homogenous particles of a single material and/or composition.

### BACKGROUND OF THE INVENTION

Since abrasive blasting began, ostensibly in the 19th century, the industry has tried a multiplicity of various materials in search of the most productive, cost-effective, and safe abrasive material. As new abrasive materials were introduced, they produced incremental improvements in various areas such as productivity, safety, or cost over various materials in the field of abrasive blasting. The industry traditionally goes in search of finding different, or better abrasives by looking for different types of materials.

As government regulations around the world increase on things like crystalline silica content, and levels of toxic metal content in abrasives, the industry has struggled to find new types of abrasive that perform to the level of existing and traditional materials. Many of the new types of abrasives introduced to address issues like human and environmental safety lack performance, and therefore lag in levels of adoption. Little has been done to look at the what these abrasive materials do, or how and why they work in an effort to improve the abrasive itself. If these new safer, but less productive abrasives can be dramatically improved in terms of performance, or if existing abrasives can be improved upon, it would be a significant finding for the abrasive blasting industry.

There is a need for a new blasting abrasive with improved performance over conventionally available blasting abrasives. There is an additional need for a method of improving the performance of conventional blasting abrasives.

### SUMMARY OF THE INVENTION

Blasting abrasives comprise a plurality of particles. Blasting abrasives are classified into two basic types with many varieties of particles within these categories. Sharp, angular, and blocky abrasives (hereinafter “SAB abrasive”) and bead and/or rounded abrasives (hereinafter “bead abrasive”). The different types of blasting abrasive are recommended for use in different applications based upon the characteristics of the particles.

Bead abrasives comprise particles having a higher degree of roundness compared to the particles in SAB abrasive. Bead abrasive is recommended in blasting processes for removing surface deposits by propelling the bead abrasive at a high pressure without significantly damaging or profiling the surface of the substrate. For example, bead abrasive blasting is preferred over SAB abrasive for automobile body paint removal to remove the coating without aggressively profiling the auto body surface. Bead blasting is also recommended for creating a uniform surface finish on machined parts, for example. Blasting with bead abrasive creates shallow substrate profiles in the shape of the bead abrasive. Blasting with bead abrasive is also known as peening.

SAB abrasives have facets, several jagged faces, and vertices. These angular abrasives are recommended in blasting applications that require cutting, or abrading for more aggressive removal of mill scale, paint, coatings, corrosion, and/or rust. SAB abrasives can both cut and create a deeper and angular surface profile on the substrate. Such a profile may be advantageous for subsequent bonding of an applied coating. The size of the abrasive particles for both SAB abrasive and bead abrasive also will influence the resulting surface profile produced on the substrate, and speed of abrading or cutting the workpiece.

The performance of a blasting abrasive is determined by preparing standardized coated panels and blasting the standardized panel with the blasting abrasive to determine the speed at which the coating is removed (square foot/min, for example), the rate of consumption of the abrasive media per area of the cleaned panel (square foot/pound, for example), and more subjective aspects including, but not limited to, the surface profile, surface rust bloom, shadowing, and degree of surface cleaning, for example.

Embodiments of the blasting abrasive comprise a mixture of the different types of abrasive media. For example, embodiments of blasting abrasive comprise a plurality of SAB abrasives and a plurality of bead abrasives. In a further embodiment, the blasting abrasive comprises a combination of SAB abrasive and bead abrasive, wherein the SAB abrasive is present in a greater concentration in the blasting abrasive than the bead abrasive. Bead abrasive and SAB abrasive both comprise a plurality of particles.

The inventor has surprisingly discovered the synergistic effect by combining SAB abrasive with bead abrasive. Even more surprising is that the inventor found that even at low concentrations the addition of bead abrasive (0.1% to 40% or, more specifically, 0.1% to 20%, or 1% to 10%, for example) to SAB abrasive improves the performance as compared to the SAB abrasive or the bead abrasive alone. The cutting rate of certain embodiments of SAB abrasive and bead abrasive provide an increased cutting rate of twice the cutting rate of the SAB abrasive alone.

In specific embodiments for SAB blasting abrasives, bead abrasive was mixed with SAB abrasive in various concentrations from 1 wt. % to 45 wt. %, this bead modified crushed glass abrasive was blast tested against the unblended SAB abrasive. In all cases, the bead modified SAB abrasive showed a higher performance than the unblended crushed glass. See the Figures.

The present invention provides an abrasive media comprising a mixture of SAB abrasive and bead abrasive. In a specific embodiment, the blasting abrasive comprises SAB abrasive and bead abrasive, wherein a concentration of the bead abrasive is between 0.1 wt. % and 40 wt. %.

Other embodiments include methods of preparing a blasting abrasive comprising mixing an SAB abrasive and a bead abrasive.

In a more specific embodiment, the present invention describes a method to substantially increase the productivity of mineral abrasives by mixing SAB mineral abrasives with bead abrasives. In embodiments of the invention, this mixing dramatically increases the productivity of even the highest performing abrasive material by itself.

The inventor theorizes that the bead modified SAB abrasives exhibit improved performance due to the previously unknow synergistic effect of the combination of abrasive shapes. The inventor believes that rounder bead abrasive imparts a Hertzian cone stress to the surface coating on the substrate that is being blasted. Hertzian cone stresses occur when a round bead with a small radius strikes a flat plate of relatively large radius. These Hertzian cone stresses create a powerful zone of stress or force at and below the area of impact. This powerful stress ripples through the surface of the coating on the substrate resulting in subsurface cracking and partial release of any coating or corrosion on the substrate below the tiny area of impact of bead and over an area greater than the diameter of bead at the surface of the substrate.

Once the coating or corrosion surface and the coating or corrosion subsurface have been cracked and/or fractured by the Hertzian cone stresses of the bead, the SAB abrasive can quickly and efficiently remove it as well as scour, clean, and lay down a rough anchor pattern on the workpiece. It is the combination of the advantages of the two types of abrasive that results in the improved performance. The SAB abrasive cutting, cleaning, and profiling action is improved by the different action of the bead abrasive so that the SAB abrasive may more efficiently prepare, clean and scour the substrate. Due to the disproportionate destructive capacity of Hertzian cone stresses, even small concentrations of bead abrasive are effective at improving the blasting efficiency of SAB abrasive. In fact, in some embodiments of the blasting abrasive with high concentrations of bead abrasive, the performance of the blasting abrasive may be lower than blasting abrasives having lower concentrations of bead abrasive due to the reduction in cutting action by the lower concentration of SAB abrasive.

Thus in one embodiment, the blasting abrasive comprises a concentration of an SAB abrasive and a concentration of another abrasive that results in greater Hertzian forces on a coating, corrosion, or mill scale of a substrate than the SAB abrasive alone under the same blasting conditions. One skilled in the art understands how to calculate or estimate Hertzian forces or Hertzian contact stresses caused by impact of particles on a substrate, coating, corrosion, or mill scale, for example.

The inventor also theorizes that embodiments of the invention provide abrasive compositions with improved flow characteristics (including more consistent flow from a blast pot, for example) from the blast pot and through the abrasive meter, the blast hose and nozzle than unmodified SAB abrasives. The bead abrasive particles may act like a lubricant or ball bearings between the SAB abrasive particles. The combination of these potential advantage result in embodiments of the bead modified SAB abrasive provide a composition of bead abrasives and SAB abrasive that improve the productivity and efficiency in abrasive blasting.

Embodiments of the present invention provide a composition of bead abrasive and SAB abrasive which improves productivity in abrasive blasting over each abrasive individually. Further embodiments provide a method of adding bead abrasives to SAB abrasives to improve the productivity and efficiency of abrasive process in either wet or dry blasting.

Embodiments of a method of abrasive blasting comprises imparting Hertzian Cone Stress on a substrate, paint, coating, corrosion, or mill scale to clean the substrate and/or prepare the substrate to be painted, coated, treated, or laid bare by simultaneously blasting with SAB abrasive. Therefore, a method of producing a blasting abrasive comprises mixing bead abrasive to an SAB abrasive, wherein the bead abrasive is in a concentration between 0.025 wt. % and 70 wt. % of the blasting abrasive. In another embodiment, the bead abrasive is in a concentration between 1 wt. % and 50 wt. % of the blasting abrasive.

In other embodiments of the blasting abrasive comprising SAB abrasive and bead abrasive, the concentration of bead abrasive in the blasting abrasive may be in the range of 0.1 wt. % to 40 wt. % or the concentration of bead abrasive in the blasting abrasive is in the range of 0.5 wt. % to 10 wt. % of the blasting abrasive. In certain embodiments, the bead abrasive has a specific gravity equal to or greater than 2.40 and/or a Knoop Hardness of not less than 400 Hk.

The bead abrasive may be a non-metallic bead abrasive or metallic bead abrasive. The bead abrasive may comprise a vitreous material (e.g. glass, mineral slag), mineral, ceramic (sintered or fused oxide), polymer, or metal (e.g. iron, steel, stainless steel), and mixtures thereof, for example.

Embodiments of the blasting abrasive include mineral slag blasting abrasives. In such embodiments, the mineral slag blasting abrasive comprises at least one mineral slag abrasive and a bead abrasive, wherein the bead abrasive is less than 70 wt. % of the weight of the blasting abrasive. The mineral slag abrasives include, but are not limited to, nickel slag, coal slag, copper slag, iron slag, steel slag, platinum slag, or combinations thereof.

Embodiments of the blasting abrasive also include naturally occurring minerals and mineral sands blasting abrasives. In such embodiments, the naturally occurring minerals and mineral sands blasting abrasives comprise at least one naturally occurring minerals and mineral sands abrasive and a bead abrasive, wherein the bead abrasive is less than 70 wt. % of the weight of the blasting abrasive. The naturally occurring minerals and mineral sands abrasives include, but are not limited to, garnet, alluvial garnet, staurolite, or combinations thereof.

Further embodiments of the blasting abrasive also include crushed glass abrasive. In such embodiments, the crushed glass blasting abrasive comprises at least one crushed glass abrasive and a bead abrasive, wherein the bead abrasive is less than 70 wt. % of the weight of the blasting abrasive.

In the embodiments of the mineral slag abrasives, naturally occurring minerals and mineral sands abrasives, and the crushed glass abrasives, the bead abrasive may comprise one of a glass bead, a ceramic bead, a steel shot, polymer bead, or combinations thereof. Also, in these embodiments, the concentration of bead abrasive may be in the range of 0.1 wt. % to 50 wt. %; 0.25 wt. % to 20 wt. %; 0.5 wt. % to 12 wt. %; or 1 wt. % to 6 wt. %.

Embodiments include a blasting abrasive comprising an SAB abrasive wherein the addition of bead abrasive results in a reduction in void space of the abrasive mixture relative to the void space of the SAB abrasive.

For any of the embodiments of the blasting abrasives comprising and SAB abrasive and bead abrasive as discussed herein, the bead abrasive may be substituted with another nonSAB abrasive in a concentration of nonSAB abrasive that is effective to increase the performance of the SAB abrasive. As such, in any embodiment described herein, a nonSAB abrasive that is not a bead abrasive may be substituted for the bead abrasive to provide a blasting abrasive.

Further embodiments include a blasting abrasive comprising any abrasive mixture of the present invention wherein the bulk density of the blasting abrasive mixture is less than the bulk density of the SAB abrasive if the specific gravity (density) of the round bead is less than that of the SAB abrasive.

Further embodiments include a blasting abrasive comprising any abrasive mixture of the present invention wherein a bulk density of blasting abrasive mixture is more than a bulk density of the SAB abrasive if the specific gravity (density) of the bead abrasive is greater than that of the SAB abrasive.

Further embodiments include a blasting abrasive comprising an SAB abrasive wherein the rate of flow of the abrasive mixture is increased over a rate of flow of the SAB abrasive by the addition of a bead abrasive. Further embodiments include a blasting abrasive comprising an SAB abrasive wherein the rate of flow of the abrasive mixture is decreased over a rate of flow of the SAB abrasive by the addition of a bead abrasive. The rate of flow may be measured by use of a timer and a funnel, for example.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

By describing the invention, a number of components, parts, techniques, and steps are disclosed. Each of these has individual benefit and each can also be used in conjunction with one or more, or in some cases, all of the other disclosed embodiments and techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### DESCRIPTION OF THE DRAWINGS

FIG. 1 is a flow sheet showing an embodiment of a method of producing an abrasive comprising an SAB abrasive and a bead abrasive;

FIG. 2 is a graph showing the blasting performance of the unblended copper slag abrasive and copper slag abrasive modified various concentration of bead abrasive in square foot of blasted area per hour;

FIG. 3 is a graph showing the consumption performance of the unblended various slag abrasive and copper slag abrasive modified various concentration of bead abrasive in pounds per square foot;

FIG. 4 is a graph showing the performance of the unblended coal slag abrasive and coal slag abrasive modified various concentration of bead abrasive in both blasted square foot of blasted area per hour and pounds per square foot blasted; and

FIG. 5 is a graph showing the performance of the unblended nickel slag abrasive and nickel slag abrasive modified various concentration of bead abrasive in both blasted square foot of blasted area per hour and pounds per square foot blasted;

### DETAILED DESCRIPTION

Abrasive blasting refers to the process of forcibly propelling a stream of abrasive particles against a surface of a substrate and/or corrosion, mill scale, a coating, or other unwanted material on the substrate at high pressure. The abrasive particles impact the surface to remove a coating, corrosion, mill scale, or other material on the surface or to change the properties or profile of that surface by making it smoother or rougher. Blasting abrasive comprise a plurality of particles. SAB abrasive or bead abrasive blasting may be used to clean and profile a surface, for example.

Conventional blasting abrasives or abrasive media are comprised of largely compositionally homogenous particles within a particle size distribution range. The particles are classified into particle size ranges by passing the particles through screens having different sized holes. The particle size range is typically defined as the particles that are separated between two sieve sizes. Abrasives may differ based on their chemical composition and their shape. Abrasives are typically produced by crushing larger particles of the desired composition (slags, glass, hard rock garnet, etc.) and separating the resultant particle size ranges. Particles of different sizes are used for different blasting operations. Naturally occurring mineral sands (silica sand, heavy mineral sands, etc.) are rarely crushed, but rather simply screened and graded.

Blasting abrasives are produced from many different compounds and may be derived from different sources. Blasting abrasive materials include, but are not limited to metal slags (e.g. nickel slag, mineral slag, coal slag, copper slag, iron slag, steel slag, and platinum slag), naturally occurring minerals and mineral sands (e.g. garnet and staurolite), ceramic, and manmade compositions fused in furnaces (e.g. aluminum oxide, glass, mineral oxide, aluminum oxide, zinc oxide, or titanium oxide. for example), and glass. Aside from newly introduced abrasive materials (e.g. calcined alumina), little has been done to improve the abrasive performance of these blasting abrasives.

The performance of a blasting abrasive is determined by preparing coated panels or new steel panels with mill scale and blasting the standardized panel with the blasting abrasive to determine the speed at which the coating is removed (square foot/min, for example), the rate of consumption of the abrasive media per area of the panel that weight of abrasive media consumed (square foot/pound, for example), and more subjective aspects including, but not limited to, the surface profile, surface rust bloom, shadowing, and degree of surface cleaning, for example. Some coatings are more difficult to remove than other coatings.

Typically, an abrasive that cleans a larger area than another abrasive, over the same period of time, is more productive and considered to be a higher performance abrasive. However, the amount of abrasive consumed to clean the area may also be considered in an economic analysis of the blasting operation. An abrasive that uses a lower quantity of abrasive (typically measured by weight) than another abrasive, to clean a given area (unit area, for example, square feet or square meter) may be more economical in a particular blasting operation. The key factors in performance analysis are area cleaned (A), elapsed time (T), and amount of abrasive used (M). Also, considered in a choice of an abrasive for a specific project is the desired use of the substrate after cleaning, the hazards use of the abrasive poses to blasters and other personnel, and the environmental considerations of use of particular abrasive at the job site, for example.

One factor that is known to impact the use, productivity, and/or performance of an abrasive is the shape of the abrasive particles. Abrasive particles come in many different shapes including, but not limited to, sharp, angular, subangular, blocky, rounded, and spherical, for example. SAB abrasives include, but are not limited to, sharp, subangular, blocky, and angular abrasive particles are defined as having mostly sharp edges and may be elongated. SAB abrasives include, but are not limited to, steel grit, crushed ceramic, crushed glass, broken glass, crushed mineral slags, coal slags, garnets, staurolite, olivine, omphacite, corundum, flint, rutile, ilmenite, sillimanite, magnetite, hematite, barite, zircon, leucoxene, fused or sintered minerals, sintered serpentinite and combinations thereof, for example.

The materials may be comminuted by natural forces (erosion, etc.), or crushed by known methods to provide sharp and angular shape that increases the cutting capability of the abrasive. Blocky abrasive particles are defined as having mostly flat edges and are usually less elongated than sharp or angular abrasive particles. As used herein, blocky abrasives include, but are not limited to, alluvial garnet, for example. Alluvial garnet may be procured from processes including, but not limited to, collection from alluvium, where water erosion has flattened the edges. In the present invention, SAB is defined abrasive particles that are either sharp, angular, or blocky, or contain some combination of sharp, angular, or blocky particles.

Bead abrasive particles are defined as having round edges. Spherical particles are defined as being more spherical than rounded abrasive particles and include non-perfect spheres, perfect spheres, and spherocylinders. As used herein, a bead abrasive is defined as abrasive particles that are either rounded or spherical or contain some combination of round and spherical particles. Round or bead abrasives have a roundness greater than 0.6 and/or a sphericity above 0.6 as measured in comparison to a chart developed by W. C. Krumbein and L. L. Sloss in Stratigraphy and Sedimentation (2nd Ed., W.H. Freeman & Co., San Francisco, Calif., 1963, p. 111) or other standard methods including ASTM D-1155 and/or AASHTO PP-74. A bead abrasive is less productive and is a lower performance abrasive than SAB abrasives but has other advantages for certain blasting options.

As used herein, bead abrasives include, but are not limited to, steel shot, ceramic beads, a glass (or vitreous) bead abrasive, reflective glass bead, round proppants, rounded steel or other metal slags, polymer beads, or mineral wool shot, for example. Mineral wool shot is produced from a molten oxide mixture solidified during the production process of mineral wool. Other mineral or slag shot materials are produced when molten oxide mixtures are poured on to a spinning surface such as a wheel or disk or poured into a high-velocity stream of air. The glass bead may also be a higher density glass bead. For example, typical container glass has a specific gravity between 2.4 and 2.55. Glass may be produced with or modified with components that increase the density. Therefore, embodiments of the bead abrasive include bead abrasives having a specific gravity in the range of 2.6 to 3.1. As such, the bead abrasive may be a glass bead abrasive having a specific gravity in the range of 2.6 to 3.1.

As used herein, non-vitreous means a material does not primarily comprise a glassy phase. For example, a non-vitreous material would comprise less than 10% by weight of glassy phase.

In specific embodiments, the bead abrasive may comprise at least one of glass beads, ceramic bead proppants, or reflective glass beads, for example. The bead abrasive may comprise a soda lime glass bead abrasive including glass beads produced from recycled glass. In embodiments wherein the bead abrasive is a glass bead abrasive, the glass bead abrasive may be combined with a crushed glass abrasive. The crushed glass SAB abrasive may be a recycled crushed glass abrasive.

The current understanding in the art is that the performance of an abrasive particle is largely based on the density, hardness, and shape of the edges of the particle. Productivity increases when a particle is able to abrade or cut a surface and clean unwanted materials and coatings from that surface efficiently. Conventionally, SAB abrasives are considered the most productive, due to the sharp edges of the abrasive particles being able to cut surfaces more effectively on impact. As used herein, this ability of abrasive particle shapes to cut surfaces may be referred to as cutting power or performance. Blocky abrasives are also productive abrasives which, due to their flat edges and sharp edges, are moderately effective at cutting surfaces on impact. As used herein, these abrasives are collectively referred to as SAB abrasives.

On the other hand, rounded and/or spherical abrasives or bead abrasives are less productive than SAB abrasives at cutting and abrading. Bead abrasives are not able to cut into a coating or corrosion as well as SAB abrasives are able to do due to their rounded shapes. Nevertheless, rounded and spherical abrasives are used in the art, because, even without sharp or flat edges, beads are still able to clean a surface from the mere impact of the abrasive particles. Bead abrasives are frequently used to peen surfaces resulting in improved hardness. The round shaped bead abrasives, such as steel shot and glass (vitreous) beads, produce this peening effect or a wavy shaped profile that is used in applications where one does not want to significantly change the profile of the substrate surface. The bead abrasive of the blasting abrasive may be part of a material that comprises bead abrasive and also a combination of other shapes. Also, the bead abrasive may be used for other purposes in the prior art such as reflective bead, proppant or bead that is incorporated into adhesives, for example, and still be considered abrasive bead, as used herein.

The present invention introduces a dramatic shift in the understanding of how abrasives clean a substrate. Conventional understand of the mechanism of abrasive blasting does not adequately consider the effect of additional factors, such as abrasive flow, improved bulk density, a combination of cutting efficiency and Hertzian forces in cracking and cleaning coatings, and the void space of the bulk abrasive that may impact the productivity of abrasives.

The present invention describes blasting abrasives comprising a combination of at least one SAB abrasive and at least one bead abrasive result in higher performance abrasive. The addition of the bead abrasive to the SAB abrasive may result in one of the following performance improvements: reduced void space in the bulk abrasive compared to the SAB abrasive component alone; more consistent abrasive metering of the blast abrasive; increased flowability of the blasting abrasive from the blast pot compared to the SAB abrasive component alone; reduced consumption during blasting operations, and increased blasting productivity compared to either of the individual abrasive components alone. A nonSAB is any abrasive that is not classified as an SAB abrasive including, but not limited to, bead abrasives.

Embodiments of the blasting abrasive comprise at least one SAB abrasive and at least one bead abrasive or other nonSAB abrasive. In this and other embodiments, the blasting abrasive may also comprise additional components or abrasives having other shapes that are not readily classifiable as SAB abrasives or bead abrasives.

Embodiments of the blasting abrasive may comprise an SAB abrasive and a concentration of bead abrasive or other nonSAB abrasive that is effective to increase the performance of the SAB abrasive. For example, an embodiment of the blasting abrasive comprises an SAB abrasive and a concentration of bead abrasive that is effective to increase the performance of the SAB abrasive. The performance of the SAB abrasive is considered to be improved, if the speed at which the coating is removed (square foot/min, for example) is increased or the rate of consumption of the abrasive media per area of the panel that weight of abrasive media consumed (square foot/pound, for example) is reduced. In some cases, a blasting inspector may consider the performance to be improved if one of the more the subjective aspects of a blasting process, including, but not limited to, the surface profile, surface rust bloom, shadowing, and degree of surface cleaning, for example, is improved.

Embodiments of the invention include mixing an SAB abrasive and bead abrasive, wherein the bead abrasive is in a concentration at or above a concentration that improves the performance of the SAB abrasive in a blasting process and below 70 wt. % of the blasting abrasive. In another embodiment the blasting abrasive comprises an SAB abrasive, and a bead abrasive, wherein the bead abrasive is less than 50 wt. % of the weight of the blasting abrasive and above a concentration that improves the performance of the SAB abrasive in a blasting process. Bead abrasive has been shown to improve the performance of SAB abrasives in concentrations as low as 0.1 wt. %.

In another embodiment, the blasting abrasive comprises SAB abrasive and a bead abrasive, wherein the concentration of bead abrasive in the blasting abrasive is in the range of 0.1 wt. % to 50 wt. %. In a more specific embodiment, the blasting abrasive comprises an SAB abrasive and a concentration of bead abrasive in the blasting abrasive is in the range of 0.1 wt. % to 20 wt. %. In more embodiments, the blasting abrasive comprises an SAB abrasive and a bead abrasive, wherein the concentration of bead abrasive in the blasting abrasive is in the range of 0.5 wt. % to 12 wt. % or even wherein the bead abrasive in the blasting abrasive in a concentration in the range of 1 wt. % to 10 wt. %.

In specific embodiments, the blasting abrasive comprises an SAB abrasive and a bead abrasive, wherein the concentration of bead abrasive in the blasting abrasive is in the range of 1.0 wt. % to 5 wt. %.

The SAB abrasive in any embodiment may comprise 20 wt. % to 99.975 wt. % of the blasting abrasive. In more specific embodiments, the SAB abrasive in any embodiment may comprise 60 wt. % to 99.5 wt. % of the blasting abrasive. In a still further, SAB abrasive in any embodiment may comprise 67 wt. % wt. % to 99 wt. % of the blasting abrasive.

The SAB abrasive may be a combination of SAB abrasives such as a blend of different sizes of SAB abrasives, a combination of 20/40 sieve size crushed glass abrasive and 40/70 sieve size crushed glass abrasive, for example, a combination of SAB abrasives of different composition such as a combination of at least two of crushed glass abrasive, slag abrasive, or garnet abrasive. Similarly, the bead abrasive may be a combination of bead abrasives with differences in size, roundness, or chemical composition, for example.

In a more specific embodiment, the blasting abrasive consists essentially of from 0.1 wt. % to 40 wt. % of bead abrasive and from 60 wt. % to 99.9 wt. % SAB abrasive.

In a further embodiment, the blasting abrasive consists essentially of from 0.1 wt. % to 30 wt. % of glass bead abrasive and from 70 wt. % to 99.9 wt. % crushed glass abrasive. In a further embodiment, the blasting abrasive consists essentially of from 0.1 wt. % to 30 wt. % of bead abrasive and from 70 wt. % to 99.9 wt. % a slag abrasive as described herein.

In a still further embodiment, the blasting abrasive consists essentially of from 0.1 wt. % to 40 wt. % of bead abrasive and from 60 wt. % to 99.9 wt. % garnet abrasive.

In a still further embodiment, the blasting abrasive consists essentially of from 0.1 wt. % to 40 wt. % of bead abrasive, wherein the bead abrasive is at least one of a glass bead abrasive or and iron silicate abrasive and from 60 wt. % to 99.9 wt. % of SAB abrasive, wherein the SAB abrasive is at least one of a slag abrasive and a bead abrasive, wherein the bead abrasive comprises a slag abrasive.

In any of the above embodiments, the SAB abrasive may be a mineral slag abrasive including, but not limited to, coal slag abrasive, copper slag abrasive, nickel slag abrasive, or other mineral furnace slag abrasive; crushed glass abrasive, garnet abrasives, staurolite abrasives, other SAB abrasive, or combinations thereof.

In any of the above embodiments, the bead abrasive may be glass beads, ceramic beads, steel slag shot, other bead abrasive, or combinations thereof.

Embodiments also include methods of producing a blasting abrasive. A method of producing a blasting abrasive may comprise blending a bead abrasive with an SAB abrasive, wherein a concentration of bead abrasive bead abrasive in the blasting abrasive is less than a concentration of SAB abrasive in the blasting abrasive. In such an embodiment, the method comprises mixing a bead abrasive with an SAB abrasive to produce a blasting abrasive, wherein the bead abrasive is in a concentration range from 0.1 wt. % to 50 wt. %. In this embodiment, the SAB abrasive may be in a concentration from 40 wt. % to 99.9 wt. %, for example.

In one embodiment, the method comprises mixing a glass bead abrasive with an SAB abrasive to produce a blasting abrasive, wherein the glass bead abrasive is in a concentration range from 0.1 wt. % to 50 wt. %. In such an embodiment, the SAB abrasive may comprise a crushed glass abrasive and the crushed glass abrasive is in a concentration from 40 wt. % to 99.9 wt. % of the blasting abrasive.

In another embodiment, the method comprises mixing a bead abrasive with an SAB abrasive to produce a blasting abrasive, wherein the bead abrasive is in a concentration range from 0.1 wt. % to 50 wt. %.

In another embodiment, the method comprises mixing a bead abrasive with an SAB abrasive to produce a blasting abrasive, wherein the bead abrasive is in a concentration range from 0.1 wt. % to 10 wt. %.

In another embodiment, the method comprises mixing a bead abrasive with an SAB abrasive to produce a blasting abrasive, wherein the bead abrasive is in a concentration range from 1 wt. % to 6 wt. %.

A further embodiment of the method comprises a method for preparing a blasting abrasive, comprising providing an amount of crushed glass abrasive, adding an amount of glass bead abrasive such that the concentration of bead abrasive in the blasting abrasive is between 0.1 wt. % and 35 wt. % and mixing the crushed glass abrasive and the glass bead abrasive.

The method for preparing a blasting abrasive for abrasive blasting may comprise charging a blast pot with at least one SAB abrasive and charging the blast pot with at least one bead abrasive, wherein the at least one bead abrasive is between 0.1 wt. % and 50 wt. % of a total amount of blasting abrasive charged to the blast pot. A substrate may then be blasted with the abrasive mixture.

The blasting abrasive may comprise bead abrasive and SAB abrasive, wherein the bead abrasive has a first chemical composition and the SAB abrasive has a second chemical composition and the first chemical composition is different than the second chemical composition. For example, the blasting abrasive may comprise a non-glass mineral abrasive component and a glass abrasive component. In such an embodiment, the glass abrasive may be a bead abrasive and in a concentration in a range of 0.1 wt. % to 50 wt. %, 1 wt. % to 5 wt. %, in a concentration in a range of 0.1 wt. % to 20 wt. %, in a concentration in a range of 0.5 wt. % to 20 wt. %, or in a concentration in a range of 0.5 wt. % to 10 wt. %.

Specifically, for any of the mineral slag abrasives, the bead abrasive may be in a concentration in a range of 0.1 wt. % to 50 wt. %, 1 wt. % to 5 wt. %, in a concentration in a range of 0.1 wt. % to 20 wt. %, in a concentration in a range of 0.5 wt. % to 20 wt. %, or in a concentration in a range of 0.5 wt. % to 10 wt. %.

Also, for any of the mineral abrasives such as, but not limited to, garnet and staurolite, the bead abrasive may be in a concentration in a range of 0.1 wt. % to 50 wt. %, 1 wt. % to 5 wt. %, in a concentration in a range of 0.1 wt. % to 20 wt. %, in a concentration in a range of 0.5 wt. % to 20 wt. %, or in a concentration in a range of 0.5 wt. % to 10 wt. %.

Finally, any other SAB abrasive, the bead abrasive may be in a concentration in a range of 0.1 wt. % to 50 wt. %, 1 wt. % to 5 wt. %, in a concentration in a range of 0.1 wt. % to 20 wt. %, in a concentration in a range of 0.5 wt. % to 20 wt. %, or in a concentration in a range of 0.5 wt. % to 10 wt. %.

Without being bound by any particular theory, the inventor believes that one factor for improving the performance of the SAB by adding a bead abrasive in an effective concentration is to reduce the void space of the original SAB abrasive. A reduced void space is one wherein a void space in the blasting abrasive comprising the SAB abrasive and bead abrasive is less than a void space of the SAB abrasive alone. As previously stated, the SAB abrasive or the bead abrasive may be a single abrasive component or a plurality of abrasive components.

Void space is the volume or interstice between particles. As used herein, void space and void volume are the same and represent the percentage of volume not occupied by abrasive material within a full container of abrasive material. For example, a blast pot filled with angular abrasives will have a high percentage of volume in that container that is not occupied by the angular abrasives due to the high surface-area-to-volume ratio of the geometric shapes of particles with sharp edges. Conversely, for example, a blast pot filled with bead abrasives will typically have a low percentage of volume in that container that is not occupied the bead abrasives due to the low surface-area-to-volume ratio of geometric shapes that are spherical. To demonstrate the difference in void space between SAB abrasives and bead abrasives, the inventor used a 28.07 ml pycnometer to measure the void volume of the two abrasives.

The mixture of bead abrasives with SAB mineral abrasive media may result in a decrease in void space in the mixed abrasive when compared to the SAB mineral abrasive alone. This mixture also improves the abrasive metering and flow characteristics through the nozzle and coating removal and cleaning properties of a blended SAB/bead abrasive media when compared to the SAB mineral abrasive or bead abrasive of the SAB/bead abrasive alone, thus resulting in an increase in productivity of the abrasive media blasting process.

This measurement showed that the sample of SAB abrasives had a typical void volume of less than 39%, while the sample of bead abrasives had a typical void volume of less than 35%. Therefore, within a given container, more bead abrasive particles by volume can fit into a container than angular abrasive particles. The presence of more abrasive particles in a blast pot results in more “hits” that the blast pot can deliver to a target surface. As used herein, a “hit” refers to an abrasive particle that has been propelled and contacts its target surface or the feed rate of the abrasive may be reduced to provide the same or less hits per time.

More hits on a surface may result in more cleaning of that surface, especially when the hits include a combination of Hertzian stress forces and SAB cutting forces. Therefore, reduced void space results in more hits on the surface, which may positively impact the productivity of the abrasive. Decreasing void space within an abrasive mixture meaningfully increased the productivity of the abrasive. However, the effectiveness of a hit depends on the properties of the abrasive as discussed above and the consistency of the flow of abrasive through the blasting nozzle. Generally, a hit from an SAB abrasive provides more cutting and efficiency than a hit from a bead abrasive.

With the aid of a pycnometer to measure individual abrasive particles or small groups of abrasive particles, void space may be calculated using the following equation: V_{V}=(S_{G}−D_{B})/S_{G}, where V_{V} is void volume (as % volume), S_{G} is specific gravity, and D_{B} is tapped bulk density. Measurements and calculations of specific gravity and tapped bulk density are both known in the art. Unless otherwise specified, this equation is used to measure or calculate void space used herein.

Mesh size refers to the size of abrasive particles and is known to influence the anchor pattern (profile) of a surface being blasted. The present invention introduces a new way of thinking about mesh size, because mesh size may have an effect on void space, which in turn effects productivity of a mixture of abrasives. The combination of different mesh sizes in a mixture of abrasive media may contribute to reducing void space and increasing the productivity of the mixture. Mesh sizes and sizes of abrasive particles may differ in both SAB abrasives and bead abrasives.

Another factor contributing to abrasive productivity which prior art failed to adequately consider is abrasive flow. As used herein, flow refers to the ease at which abrasive particles may for example accumulate in bottom of a blast pot, feed into an abrasive metering device, be propelled from a blast pot, through an abrasive metering device, blast hose, and blast nozzle, and from the blast nozzle to the surface to be cleaned. In the art, higher flowability, more consistent, or improved flow is generally preferred, while uneven, inconsistent, and decreased flowability is not preferred. The flowability of different abrasives may be measured by comparing the amount of abrasive propelled from a blast pot when using the same nozzle, the same abrasive meter settings, and applying the same force or pressure on the particles. Typically, the flow times of SAB abrasives are higher than that of bead abrasives of the same size because SAB abrasives have edges, which are prone to interlocking and bridging, at least temporarily, reducing flowability or clumping together. This interlocking requires higher (richer) abrasive meter settings, increasing the amount of abrasive used per unit area. The interlocking of SAB abrasives results in an inconsistent stream of abrasive material, as some particles interlock randomly and create blockage in the abrasive blasting system, while other particles randomly fail to interlock and continue to be propelled onto the surface. This inconsistent stream of SAB abrasives and randomly occurring blockage results in the average SAB abrasive particles hitting the surface with reduced force, the flow of the SAB abrasive is lower than that of bead abrasives, and with inconsistent angles of impact. Inconsistent flow ultimately negatively impacts productivity. Bead abrasives, on the other hand, lack edges that could interlock; thus, the flow of bead abrasives is more consistent and straighter than that of SAB abrasives.

In the present invention, it was discovered that a mixture of bead abrasives with SAB abrasives can significantly increase speed or rate of flow when compared to, for example, SAB abrasives alone—depending upon the level of bead loading through a funnel. Glass beads are an example of a bead abrasive. Even though the glass beads were less efficient abrasives than the SAB abrasives in terms of abrading power, it is theorized that the increased flowability of this mixture is due to the round and spherical shape of bead abrasives, which may be considered to act as tiny ball bearings in the mixture and prevent the SAB particles from interlocking. The increased consistency of flow of this mixture also allows for leaner abrasive meter settings, and more accurate and economical abrasive metering. As used herein, abrasive metering is the process of setting a certain level of abrasive flow depending on a number of factors, including the type of equipment being used, the surface being cleaned or substrate being clean from that surface.

The present invention describes how a mixture of bead abrasives and SAB abrasives results in decreased void space, when compared to SAB abrasives alone. This decreased void space working synergistically with the presence of SAB abrasives, which are known to have more cutting power due to the edges of the particles, and increased flow consistency results in a mixture with increased productivity when compared to either SAB abrasives alone or bead abrasives alone. Experiments with proper controls were established to compare the productivity of a mixture of bead abrasives and SAB abrasives to each individual abrasive component. The results of these experiments showed that the mixture had a higher productivity than SAB abrasives, and SAB abrasives had a higher productivity than bead abrasives. The results of these experiments also showed that only certain proportions of bead abrasive to SAB abrasive produce a mixture with increased productivity when compared to each individual abrasive component. A balance must be struck between flow, void space, and cutting power to achieve increased productivity. For example, a mixture comprised of 99.99% bead abrasive and 0.01% SAB abrasive may not produce a synergistic effect that results in measurable increased productivity when compared to each individual abrasive component.

The present invention considers other factors which also have an effect on abrasive productivity, including, but not limited to, the difference in specific gravity between the individual abrasive components within a mixture, hardness of abrasive components within a mixture, and uniformity within each component of the mixture. Specific gravity is measured by the density of the particle relative to the density of water. If specific gravity is high, then the abrasive is heavier. When blasted at the same pressure, a heavy or more dense abrasive has the ability to impact the substrate with more force than a lighter abrasive, when other factors, like shape of the abrasive particle, are controlled. Further, the specific gravity of abrasives tends to have a direct relationship on the amount of work the abrasive does. The definition of Work is; Work=½ Mass×Velocity². Abrasive particles with the same velocity but greater mass, are generally more productive. Minimizing differences between the specific gravity of the individual components of a mixture helps reduce the potential for segregation of the components during manufacturing, packaging, transporting, and charging the blast pot. Segregation of the individual abrasive components within a mixture may negatively impact the flow of the abrasive mixture by prohibiting a uniform stream of abrasive particles from being propelled. The hardness of abrasive media is also an important factor in abrasive productivity as only materials that are harder than the coating or substrate can effectively scratch or etch the lower hardness materials. As used herein, hardness is measured with Knoop hardness.

The preferred embodiment of invention comprises a mixture of SAB abrasives and bead abrasives. This mixture has increased productivity when compared to SAB abrasives alone and when compared to bead abrasives alone. The bead abrasive component of the mixture uses recycled crushed soda lime glass as the abrasive material. The SAB abrasive component of the mixture uses a non-glass material (such as alluvial garnet) as the abrasive material. The proportion of SAB abrasives to bead abrasives in the mixture is between 82 to 18 and 60 to 40, though mixtures outside this range may provide benefit. In certain embodiments, the proportion of SAB abrasives to bead abrasives in the mixture is between 90 to 10 and 55 to 45. Yet in other embodiments, the proportion of SAB abrasives to bead abrasives in the mixture is between 97 to 3 and 45 to 55.

In certain embodiments, the void space of the mixture is less than or equal to the void space of the SAB abrasive component alone. In other embodiments, the specific gravity of the bead abrasive component of the mixture is similar to the SAB abrasive component of the mixture but is not less than 2.4.

Typically, the hardness of the bead abrasive component of the mixture is greater than or equal to HK=500 kg/mm². The above specified factors such as the selection of specific abrasive materials to create the abrasive, proportion of SAB abrasive to bead abrasive, specific gravity, void space, and hardness were found during testing to result in increased productivity in this embodiment.

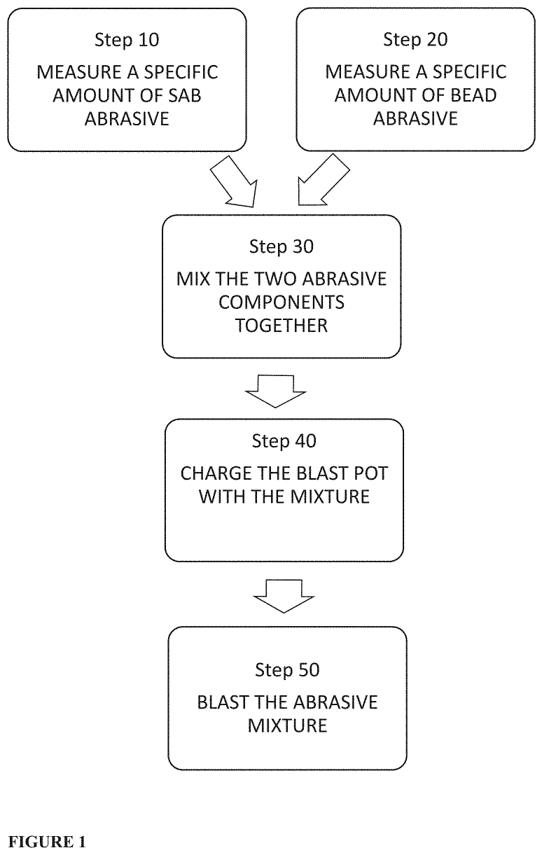

Looking now to FIG. 1, in the preferred embodiment of the invention, the method used for preparing the mixture of abrasive media for abrasive blasting comprises the following: measuring specific amounts of SAB abrasive and bead abrasive, mixing the two abrasive components together in any of the embodiments described herein, charging the blast pot with the mixture, and blasting the abrasive mixture. Embodiments of the method provide for controlling the bead loading levels relative to the SAB abrasive content.

Another embodiment of the invention comprises all of the features of the preferred embodiment, except that the SAB abrasive component is a glass abrasive material. Yet, another embodiment of the invention, uses a different method for preparing a mixture of abrasive media for abrasive blasting. This method comprises the following steps: obtaining a pre-mixed abrasive media, charging the blast pot, and blasting the abrasive mixture. The pre-mixed abrasive media may be a mixture of at least one SAB abrasive and at least one bead abrasive, for example, a glass bead abrasive.

In any embodiment, the at least one SAB abrasive may be a plurality of SAB abrasives that comprise at least one different property. The at least one different property may be a chemical or physical property. The chemical or physical properties of the SAB abrasive may vary by chemical composition, crystalline structure, amorphous form, average particle size, particle size distribution, angularity, shape, or other chemical or physical property. The at least one glass bead abrasive may comprise glass beads comprising different chemical or physical properties. The chemical or physical properties of the glass bead may vary by chemical composition, amorphous structure, average particle size, particle size distribution, roundness, shape, or other chemical or physical property. Similarly, the bead abrasive may be a combination of different bead abrasives.

Further embodiments of the blasting abrasive comprise an SAB abrasive and a bead abrasive in any of the concentration rages described herein, wherein the SAB abrasive has an SAB average particle size and the bead abrasive has a bead average particle size and the bead average particle size is less than the SAB average particle size. The average particle size of the particles of either the SAB abrasive or the bead abrasive can be measured by know laboratory techniques. In certain applications, if the bead average particle size is less than the SAB average particle size the performance of an SAB abrasive can be improved, including but not limited to, crushed glass abrasives, mineral slag abrasives, and naturally occurring mineral and mineral sand abrasives.

Another embodiment of the invention comprises a mixture of a non-glass mineral abrasive component and a glass abrasive component. The non-glass mineral abrasive component may be a non-glass SAB mineral abrasive component and the glass abrasive component may be a glass bead. This mixture results in increased productivity when compared to the mineral abrasive component alone.

Yet, another embodiment of the invention comprises a mixture of a first abrasive component and a second abrasive component, the second abrasive component having a lower void space than the first abrasive component, and wherein the resulting mixture of abrasive media has a lower void space than first abrasive component.

Another embodiment of the invention comprises a mixture of two or more SAB abrasive components and at least one bead abrasive component. Yet, another embodiment of the invention comprises a mixture of two or more bead abrasive components and one SAB abrasive component.

Another embodiment of the invention comprises a mixture of a SAB abrasive component and a bead abrasive component, wherein the two components have different mesh sizes, and the difference in mesh sizes increases the productivity of mixture compared to each individual abrasive component. Yet, another embodiment of the invention comprises a mixture of one or more SAB abrasive components (each SAB component having a different mesh size from the other) and one or more bead abrasive components (each bead component having a different mesh size from the other), wherein the combination of mesh sizes increases the productivity of mixture compared to each of the various abrasive components.

For example, in one embodiment of the abrasive mixture, the SAB abrasive component uses glass as the abrasive material and the bead abrasive component uses glass as the abrasive material; the proportion of SAB abrasives to bead abrasives in the mixture is 70 to 30. The present invention may be better understood using alternate language. The following section describes the same invention in slightly different terms and with a different organizational structure; this alternate description would also be readily understood by a person having ordinary skill in the art.

### Summary of Abrasive Mixture Invention

Some of the embodiments of the blasting abrasive may comprise the following characteristics.
A mixture of abrasive media comprising SAB abrasive and at least one bead or shot component.
Bead or shot component or media may comprise preferably glass (e.g. soda lime glass or other amorphous glass or vitreous material in including glass made from waste concrete), mineral slag or shot, fused and sintered mineral, ceramic, polymer, and iron or steel bead or shot or combinations thereof.

### Additional Benefits of Abrasive Mixture

Reduced friction and wear on blast system components
Reduced concentrations of deleterious SAB abrasive compositions
Simultaneously provides fourfold surface preparation action—abrading (cutting),
   cleaning or scouring, profiling, and peening
May delay rust bloom
   Why does this Abrasive Mixture Work?
   Some or all of these factors are theorized to contribute to the effectiveness of embodiments of the blasting abrasives described herein.
Bead or shot serves may act as ball bearings for the SAB reducing friction (locking and bridging) and increasing flow dynamics of the mixture allowing for leaner abrasive meter settings
   Leaner Abrasive Streams are More Effective than Over-Fed Streams
Leaner abrasive streams are more economical than over-fed streams
Bead or shot in parallel flows to containment surfaces is less erosive and generates less friction enhancing service life of blast system hoses and nozzles.
Bead or shot delivers an impact shock wave (Hertzian contact stress) that may be different in shape and propagation, and more intense in severity than SAB abrasives.
Bead or shot tends to break down less rapidly than SAB abrasives particles because the contact area at the point of impact on bead or shot is smaller than that of SAB abrasive particles.

In certain embodiments, a specific gravity of the bead abrasive component of the mixture is similar to the SAB abrasive component of the mixture but is not less than 2.4.

### EXAMPLES

The performance of the blast abrasive was tested by cleaning steel plate with mill scale and steel painted panels.

The tests were conducted with a 2021 Schmidt® Amphiblast Lite from Axxiom Manufacturing, Inc. The blast pot was pressurized with a 375 CFM (97.6 HP) compressor from Kaeser Compressors, Inc. and the air flow was pretreated and dried with a Schmidt® Air Dryer System from Axxiom Manufacturing, Inc.

The testing was performed with a typical nozzle pressure of 100 psi (unless otherwise noted) in the blast hose adjacent to the blast nozzle. A No. 7 blast nozzle was used to perform the tests except the fine copper slag abrasives were blasted with a No. 8 nozzle. The media supply valve on the Amphiblast Lite was opened 4.5 to 5 turns to provide the appropriate blast flow and pattern.

The blast pot was charged with ten pounds of abrasive for each blast test. The area (square feet) of blasted prepared or cleaned surface, the time to prepare that area, and the time for the blast pot to empty were measured for each test and the data in the table was calculated from this information. From this test data, the rate of preparing or cleaning the panel with each particular panel was determined, the consumption of blasting media consumed per area, and the flow rate of abrasive through the system was calculated.

The data is shown in graphs in the figures wherein the data trendline in the graphs are least squares fits of linear regression models. For the lb./sq.ft. charts, a regression model was used with terms for the additive level and the slag type. The regression model for the sq.ft./hr. included the following terms: slag type, additive level, the slag type-additive level interaction, and the additive level quadratic term.

### Example 1

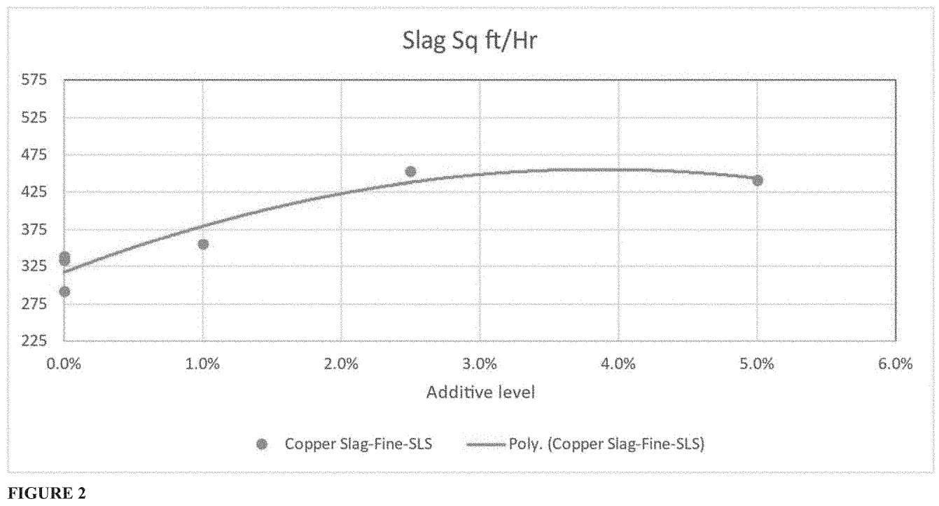

A copper slag abrasive was tested as described above. The copper slag abrasive was blasted and with various concentrations of sodium lime silicate glass beads. The results are shown in Table 1 and in FIG. 2.

The blasting performance evidences a significant rate (sqft/hr increase) between unmodified and modified copper slag.

TABLE 1
Copper Slag Abrasive - Size: Fine with SLS glass bead from
Ballotini (Size AB (Sieve Size: 50 × 80)
Substrate: Mill Scale on Bare Steel

| | | | | Meter |
|---|---|---|---|---|
| Modifier Loading | SqFt/Hr | Lbs/SqFt | Lbs/Min | Turns |
| 0.00% | 291 | | 12.3 | 3.0 |
| 0.00% | 333 | | 13.9 | 3.0 |
| 0.00% | 338 | | 14.1 | 3.0 |
| 1.00% | 356 | | 14.8 | 3.0 |
| 2.50% | 453 | | 18.9 | 3.0 |
| 5.00% | 440 | | 18.3 | 3.0 |

### Example 2

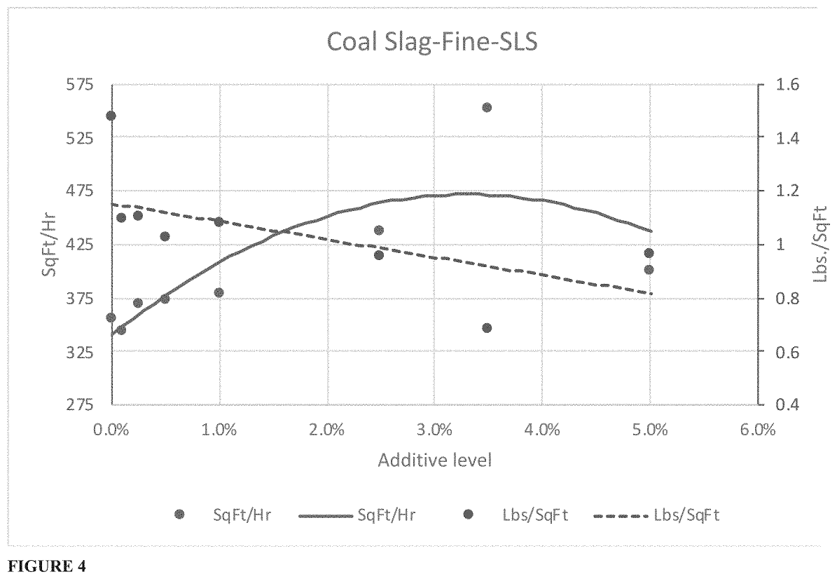

A coal slag abrasive was tested as described above. The coal slag abrasive was blasted and with various concentrations of sodium lime silicate glass beads. The results are shown in Table 2 and in FIG. 4.

The blasting performance evidences a significant rate (sqft/hr increase) and reductions in abrasive consumption between unmodified and modified copper slag even at concentrations as low as 0.1 wt. % with the same blasting equipment having the same settings. The cutting rate shows a maximum between 2.5 wt. % and 3.5 wt. % in these tests.

At a concentration of 40 wt. % of glass bead the cutting rate of the modified coal slag abrasive was lower than unmodified coal slag.

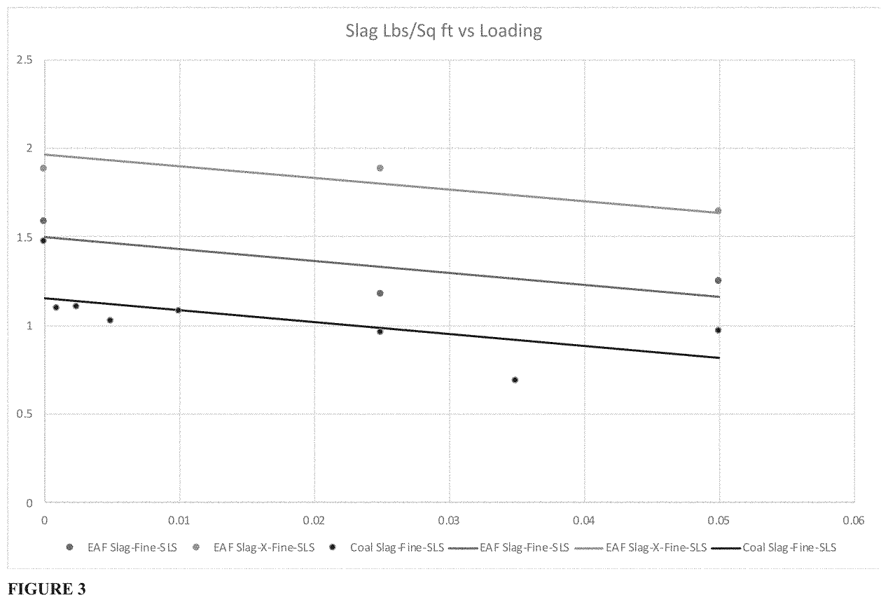

The consumption rates are also reduced while the performance is increased. See FIG. 3.

TABLE 2
Coal Slag Abrasive - Size: Fine with SLS glass bead from
Ballotini (Size AA (Sieve Size: 25 × 45)
Substrate: Mill Scale on Bare Steel

| | | | | Meter |
|---|---|---|---|---|
| Modifier Loading | SqFt/Hr | Lbs/SqFt | Lbs/Min | Turns |
| 0.0% | 355 | 1.5 | 8.7 | 5.0 |
| 0.1% | 343 | 1.1 | 6.3 | 5.0 |
| 0.25% | 369 | 1.1 | 6.8 | 5.0 |
| 0.50% | 372 | 1.0 | 6.3 | 5.0 |
| 1.00% | 378 | 1.1 | 6.8 | 5.0 |
| 2.50% | 436 | 1.0 | 6.9 | 5.0 |
| 3.50% | 552 | 0.7 | 6.3 | 5.0 |
| 5.00% | 400 | 1.0 | 6.4 | 5.0 |
| 10.00% | 403 | 0.9 | 5.9 | 5.0 |
| 20.00% | 338 | 1.2 | 6.7 | 5.0 |
| 40.00% | 290 | 1.4 | 6.5 | 5.0 |

### Example 3

A coal slag abrasive was tested as described above. The coal slag abrasive was blasted and with various concentrations of ceramic beads. The results are shown in Table 4.

The blasting performance evidences a significant reduction in abrasive consumption between unmodified and modified copper slag even at concentrations as low as 2.5 wt. % with the same blasting equipment having the same settings.

TABLE 3
Coal Slag Abrasive - Size: Fine with ceramic
bead from Carbo Ceramics, Inc.
Substrate: Mill Scale on Bare Steel

| | | | | Meter |
|---|---|---|---|---|
| Modifier Loading | SqFt/Hr | Lbs/SqFt | Lbs/Min | Turns |
| 2.50% | 358 | 1.0 | 5.8 | 5.0 |

### Example 4

A garnet abrasive was tested as described above. The garnet abrasive was blasted and with various concentrations of sodium lime silicate glass beads. The results are shown in Table 4.

The blasting performance evidences a significant rate (sqft/hr increase) and reductions in abrasive consumption between unmodified and modified garnet even at concentrations as low as 2.5 wt. % with the same blasting equipment having the same settings. The cutting rate shows a maximum near a concentration range of 2.5 wt. % tests.

At a concentration of 20 wt. % of glass bead the cutting rate of the modified garnet abrasive was lower than unmodified garnet abrasive.

TABLE 4
Garnet Abrasive - Size: (3060) with SLS glass bead from
Ballotini (Size AA (Sieve Size: 25 × 45)
Substrate: Mill Scale on Bare Steel

| | | | | Meter |
|---|---|---|---|---|
| Modifier Loading | SqFt/Hr | Lbs/SqFt | Lbs/Min | Turns |
| 0.0% | 366 | 1.9 | 11.9 | 5.5 |
| 2.5% | 407 | 0.9 | 5.9 | 4.0 |
| 5.0% | 362 | 0.9 | 5.6 | 4.0 |
| 10.0% | 331 | 1.0 | 5.6 | 4.0 |
| 20.0% | 325 | 1.1 | 5.8 | 4.0 |

### Example 5

The same garnet abrasive as tested in Example 4 was tested as described above. In this example, the garnet abrasive was blasted and with various concentrations of ceramic beads. The results are shown in Table 5.

The blasting performance evidences a significant rate (sqft/hr increase) and reductions in abrasive consumption between unmodified and modified garnet even at concentrations as low as 2.5 wt. % with the same blasting equipment having the same settings. The cutting rate shows a maximum near a concentration range of 2.5 wt. % tests.

At a concentration of 20 wt. % of glass bead the cutting rate of the modified garnet abrasive was lower than unmodified garnet abrasive as shown in Example 4.

TABLE 5
Garnet Abrasive - Size: (3060) with SLS glass bead from
Ballotini (Size AA (Sieve Size: 25 × 45)
Substrate: Mill Scale on Bare Steel

| | | | | Meter |
|---|---|---|---|---|
| Modifier Loading | SqFt/Hr | Lbs/SqFt | Lbs/Min | Turns |
| 0.0% | 366 | 1.9 | 11.9 | 5.5 |
| 2.5% | 407 | 0.9 | 5.9 | 4.0 |
| 5.0% | 362 | 0.9 | 5.6 | 4.0 |
| 10.0% | 331 | 1.0 | 5.6 | 4.0 |
| 20.0% | 325 | 1.1 | 5.8 | 4.0 |

### Example 6

The same garnet abrasive as tested in Example 4 was tested as described above. In this example, the garnet abrasive was blasted and with various concentrations of sodium lime silicate beads having a different particle size distribution that those tested in Example 4. The results are shown in Table 6.

The blasting performance evidences a significant reduction in abrasive consumption between unmodified and modified garnet even at concentrations as low as 2.5 wt. % with the same blasting equipment having the same settings.

TABLE 6
Garnet Abrasive - Size: (3060) with SLS glass bead from
Ballotini (Size AB (Sieve Size: 50 × 80)
Substrate: Mill Scale on Bare Steel

| | | | | Meter |
|---|---|---|---|---|
| Modifier Loading | SqFt/Hr | Lbs/SqFt | Lbs/Min | Turns |
| 0.0% | 366 | 1.9 | 11.9 | 5.5 |
| 2.50% | 267 | 1.3 | 5.6 | 4.0 |
| 5.00% | 305 | 1.2 | 6.0 | 4.0 |
| 10.0% | 295 | 1.2 | 5.8 | 4.0 |
| 20.0% | 306 | 1.2 | 6.0 | 4.0 |

### Example 7

A garnet abrasive was tested as described above. In this example, the garnet abrasive was blasted and with various concentrations of ceramic beads. The results are shown in Table 7.

The blasting performance evidences a significant rate (sqft/hr increase) and reductions in abrasive consumption between unmodified and modified garnet even at concentrations as low as 2.5 wt. % with the same blasting equipment having the same settings on both bare steel and painted panels. The cutting rate shows a maximum near a concentration range of 2.5 wt. % tests.

TABLE 7
Garnet Abrasive - Size: (36) with ceramic bead from Carbo Ceramics, Inc.
Substrate: Mill Scale on Bare Steel

| | | | | Meter |
|---|---|---|---|---|
| Modifier Loading | SqFt/Hr | Lbs/SqFt | Lbs/Min | Turns |
| 0.0% | 390 | 0.9 | 6.1 | 4.0 |
| 2.5% | 466 | 0.8 | 5.9 | 4.0 |
| Substrate: Painted Panels | | | | |
| 0.0% | 214 | 1.4 | 5.1 | 4.0 |
| 2.50% | 277 | 1.3 | 5.8 | 4.0 |
| 2.50% | 393 | 0.9 | 5.7 | |

### Example 8

A staurolite abrasive was tested as described above. The staurolite abrasive was blasted and with various concentrations of ceramic beads. The results are shown in Table 8.

The blasting performance evidences a significant rate (sqft/hr increase) and reductions in abrasive consumption between unmodified and modified garnet even at concentrations as low as 2.5 wt. % with the same blasting equipment having the same settings.

TABLE 8
Staurolite Abrasive with ceramic bead from Carbo Ceramics, Inc.
Substrate: Mill Scale on Bare Steel

| | | | | Meter |
|---|---|---|---|---|
| Modifier Loading | SqFt/Hr | Lbs/SqFt | Lbs/Min | Turns |
| 0.0% | 129 | 2.9 | 6.1 | 4.0 |
| 2.50% | 148 | 2.6 | 6.3 | 4.0 |
| 0.0% | 129 | 2.9 | 6.1 | 4.0 |
| 2.50% | 153 | 2.5 | 6.5 | 4.0 |

### Example 9

A nickel slag abrasive was tested as described above. The nickel slag abrasive was blasted and with various concentrations of sodium lime silicate glass beads. The results are shown in Table 9.

The blasting performance evidences a significant rate (sqft/hr increase) and reductions in abrasive consumption between unmodified and modified garnet even at concentrations as low as 0.25 wt. % with the same blasting equipment having the same settings. The cutting rate shows a maximum near a concentration range of 3.5 wt. % tests but shows significant rate improvements and consumption reduction at all modifier concentrations.

TABLE 9
Nickel Slag Abrasive - Size: Fine with ceramic bead from
Carbo Ceramics, Inc. (Size: 40 × 70)
Substrate: Mill Scale on Bare Steel

| | | | | Meter |
|---|---|---|---|---|
| Modifier Loading | SqFt/Hr | Lbs/SqFt | Lbs/Min | Turns |
| 0.00% | 347 | | 5.3 | 4.0 |
| 0.25% | 369 | 0.74 | 4.6 | 4.0 |
| 0.50% | 541 | 0.48 | 4.3 | 4.0 |
| 1.00% | 478 | 0.60 | 4.7 | 4.0 |
| 2.50% | 424 | 0.57 | 4.0 | 4.0 |
| 5.00% | 360 | 0.65 | 3.9 | 4.0 |
| 10.00% | 428 | 0.56 | 4.0 | 4.0 |
| 0.00% | 333 | 0.88 | 4.9 | 4.0 |
| 0.10% | 384 | 0.74 | 4.8 | 4.0 |
| 0.25% | 459 | 0.62 | 4.7 | 4.0 |
| 0.50% | 386 | 0.72 | 4.6 | 4.0 |
| 1.00% | 441 | 0.71 | 5.2 | 4.0 |
| 2.50% | 449 | 0.59 | 4.4 | 4.0 |
| 3.50% | 610 | 0.45 | 4.6 | 4.5 |
| 5.00% | 417 | 0.72 | 5.0 | 4.0 |
| 10.00% | 375 | 0.76 | 4.7 | 4.0 |
| 20.00% | 418 | 0.75 | 5.2 | 4.0 |
| 40.00% | 427 | 0.74 | 5.3 | 4.0 |

### Example 10

A nickel slag abrasive was tested as described above. The nickel slag abrasive was blasted and with various concentrations of ceramic beads. The results are shown in Table 10.

The blasting performance evidences a significant rate (sqft/hr increase) and reductions in abrasive consumption between unmodified and modified garnet even at concentrations as low as 2.5 wt. % with the same blasting equipment having the same settings.

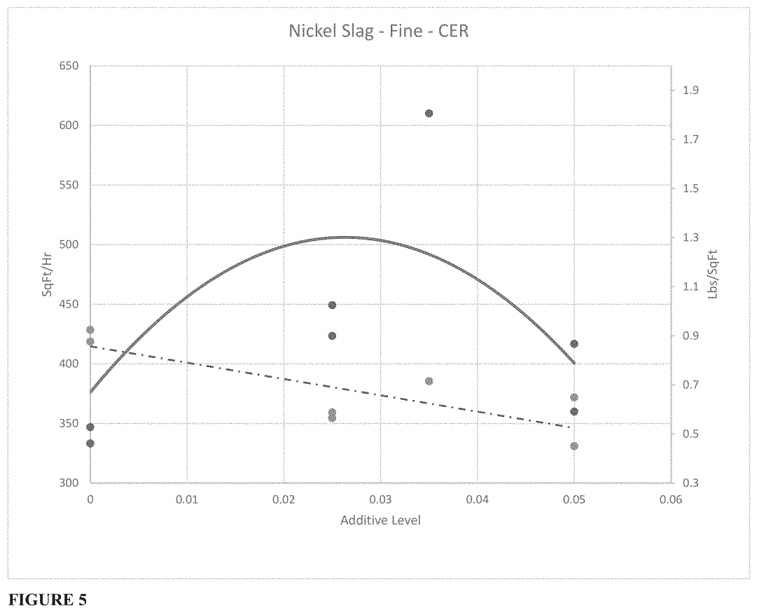

See FIG. 5.

TABLE 11
Nickel Slag Abrasive - Size: Fine with ceramic bead from
Carbo Ceramics, Inc. (Size: 30 × 60)
Substrate: Mill Scale on Bare Steel

| | | | | Meter |
|---|---|---|---|---|
| Modifier Loading | SqFt/Hr | Lbs/SqFt | Lbs/Min | Turns |
| 2.50% | 369 | 1.1 | 6.6 | 5.0 |

### Example 11

A nickel slag abrasive was tested as described above. The nickel slag abrasive was blasted and with various concentrations of sodium lime silicate glass beads. The results are shown in Table 11.

The blasting performance evidences a significant rate (sqft/hr increase) and reductions in abrasive consumption between unmodified and modified garnet even at concentrations as low as 2.5 wt. % with the same blasting equipment having the same settings.

TABLE 11
Nickel Slag Abrasive - Size: Fine with SLS glass bead from
Ballotini (Size: AB (40 × 70))
Substrate: Mill Scale on Bare Steel

| | | | | Meter |
|---|---|---|---|---|
| Modifier Loading | SqFt/Hr | Lbs/SqFt | Lbs/Min | Turns |
| 2.5% | 464 | 0.61 | 4.7 | 4.0 |
| 5.0% | 486 | 0.61 | 4.9 | 4.0 |

### Example 12

A nickel slag abrasive was tested as described above. The nickel slag abrasive was blasted and with various concentrations of steel slag beads. The results are shown in Table 12.

The blasting performance evidences a significant rate (sqft/hr increase) and reductions in abrasive consumption between unmodified and modified garnet even at concentrations as low as 2.5 wt. % with the same blasting equipment having the same settings.

TABLE 12
Nickel Slag Abrasive - Size: Fine with steel slag
bead from Duramax (50 × 80)
Substrate: Mill Scale on Bare Steel

| | | | | Meter |
|---|---|---|---|---|
| Modifier Loading | SqFt/Hr | Lbs/SqFt | Lbs/Min | Turns |
| 2.5% | 500 | 0.54 | 4.5 | 4.0 |
| 5.0% | 446 | 0.64 | 4.7 | 4.0 |

### Example 13

A crushed glass abrasive was tested as described above. The nickel slag abrasive was blasted and with various concentrations of sodium lime silicate glass beads. The results are shown in Table 13.

The blasting performance evidences a significant rate (sqft/hr increase) and reductions in abrasive consumption between unmodified and modified garnet even at concentrations as low as 2.5 wt. % with the same blasting equipment having the same settings.

TABLE 13
Crashed Glass Abrasive - Size: Medium to Coarse with SLS glass
bead from Ballotini (Size AB (Sieve Size: 50 × 80)
Substrate: Mill Scale on Bare Steel

| | | | | Meter |
|---|---|---|---|---|
| Modifier Loading | SqFt/Hr | Lbs/SqFt | Lbs/Min | Turns |
| 0.00% | 202 | 3.3 | 11.1 | 3.0 |
| 5.00% | 255 | 2.6 | 11.2 | 3.0 |
| 0.00% | 205 | 3.3 | 11.4 | 3.0 |
| 2.50% | 273 | 2.5 | 11.5 | 3.0 |
| 0.00% | 219 | 3.1 | 11.4 | 3.0 |
| 5.00% | 301 | 2.3 | 11.0 | 3.0 |

No. 8 nozzle

The embodiments and examples of the described invention and method are not limited to the particular embodiments, components, method steps, and materials disclosed herein as such components, process steps, and materials may vary. Moreover, the terminology employed herein is used for the purpose of describing exemplary embodiments only and the terminology is not intended to be limiting since the scope of the various embodiments of the present invention will be limited only by the appended claims and equivalents thereof.

Therefore, while embodiments of the invention are described with reference to exemplary embodiments, those skilled in the art will understand that variations and modifications can be affected within the scope of the invention as defined in the appended claims. Accordingly, the scope of the various embodiments of the present invention should not be limited to the above discussed embodiments and should only be defined by the following claims and all equivalents.

1. A blasting abrasive, comprising:
an SAB abrasive, and
a bead abrasive, wherein the bead abrasive is less than 70 wt. % of the weight of the blasting abrasive.

2. The blasting abrasive of claim 1, wherein the concentration of bead abrasive in the blasting abrasive is in the range of 0.1 wt. % to 50 wt. %.

3. The blasting abrasive of claim 1, wherein the concentration of bead abrasive in the blasting abrasive is in the range of 0.1 wt. % to 20 wt. %.

4. The blasting abrasive of claim 1, wherein the concentration of bead abrasive in the blasting abrasive is in the range of 0.5 wt. % to 12 wt. %.

5. The blasting abrasive of claim 1, wherein a void space in the blasting abrasive is less than a void space of the SAB abrasive component alone.

6. The blasting abrasive of claim 1, wherein the bead abrasive is at least one of glass beads abrasive, ceramic bead, or reflective glass beads.

7. The blasting abrasive of claim 6, wherein the glass bead abrasive is soda lime glass bead abrasive.

8. The blasting abrasive of claim 1, wherein the SAB abrasive is crushed glass abrasive.

9. The blasting abrasive of claim 8, wherein the bead abrasive is crushed glass abrasive having a specific gravity in the range of 2.6 to 3.1.

10. The blasting abrasive of claim 9, wherein the concentration of bead abrasive in the blasting abrasive is in the range of 0.1 wt. % to 40 wt. %.

11. The blasting abrasive of claim 9, wherein the concentration of bead abrasive in the blasting abrasive is in the range of 1 wt. % to 10 wt. %.

12. The blasting abrasive of claim 1, wherein the SAB abrasive is a combination of SAB abrasives.

13. The blasting abrasive of claim 1, wherein the bead abrasive is a combination of bead abrasives.

14. The blasting abrasive of claim 1, wherein the bead abrasive has a specific gravity in the range of 2.6 to 3.1.

15. A method of preparing a blasting abrasive, comprising:
blending a bead abrasive with an SAB abrasive, wherein a concentration of bead abrasive bead abrasive in the blasting abrasive is less than a concentration of SAB abrasive in the blasting abrasive.

16. The method of claim 15, wherein the SAB abrasive is a crushed glass abrasive.

17. The method of claim 15, wherein the bead abrasive comprises glass bead.

18. The method of claim 15, wherein the SAB abrasive is at least one of mineral slag, coal slag, copper slag, iron slag, steel slag, platinum slag, and nickel slag.

19. The blasting abrasive of claim 1, wherein the SAB abrasive is at least one of mineral slag, coal slag, copper slag, iron slag, steel slag, platinum slag, and nickel slag.

20. The blasting abrasive of claim 1, wherein the SAB abrasive component comprises at least one of a mineral oxide, aluminum oxide, zinc oxide, or titanium oxide.

21. The blasting abrasive of claim 1, wherein both the bead abrasive component and the SAB abrasive are glass abrasives.

22. A method for preparing a blasting abrasive, comprising:
providing an amount of crushed glass abrasive,
adding an amount of glass bead abrasive such that the concentration of bead abrasive in the blasting abrasive is between 0.1 wt. % and 50 wt. %; and
mixing the crushed glass abrasive and the glass bead abrasive.

23. A blasting abrasive, comprising:
a first abrasive component, wherein the first abrasive component alone has a first void space, and
a second abrasive component, wherein the second blasting abrasive component has a second void space and the second void space is lower than the first void space.

24. The blasting abrasive of claim 23, wherein the first abrasive component is an SAB abrasive and the second abrasive component is a bead abrasive.

25. The blasting abrasive of claim 24, wherein the second abrasive component is in a concentration range from 0.1 wt. % to 35 wt. %.

26. The blasting abrasive of claim 24, wherein the second abrasive component is in a concentration range from 0.1 wt. % to 12 wt. %.

27. A method for preparing a blasting abrasive for abrasive blasting comprising:
charging a blast pot with at least one SAB abrasive;
charging the blast pot with at least one bead abrasive, wherein the at least one bead abrasive is between 0.1 wt. % and 50 wt. % of a total amount of blasting abrasive charged to the blast pot; and
blasting the abrasive mixture.

28. A blasting abrasive, comprising:
a non-vitreous mineral abrasive; and
a glass abrasive wherein the glass abrasive is a bead abrasive and in a concentration in a range of 0.1 wt. % to 50 wt. %.

29. The blasting abrasive of claim 29, wherein the glass abrasive is in a concentration in a range of 0.1 wt. % to 20 wt. %.

30. The blasting abrasive of claim 29, wherein the glass abrasive is in a concentration in a range of 0.5 wt. % to 12 wt. %.

31. The blasting abrasive of claim 29, wherein the glass abrasive is in a concentration in a range of 0.5 wt. % to 8 wt. %.

32. A blasting abrasive, comprising:
crushed glass abrasive having a particle size between sieve size 40 and sieve size 70; and
glass bead having a particle size between sieve size 40 and sieve size 70.

33. A blasting abrasive, comprising:
a mineral slag SAB abrasive; and
a bead abrasive, wherein the bead abrasive is in a concentration range of 0.1 wt. % to 20 wt. %.

34. A blasting abrasive, comprising:
a coal slag abrasive; and
a bead abrasive, wherein the glass abrasive is a bead abrasive and in a concentration in a range of 0.1 wt. % to 50 wt. %.

35. The blasting abrasive of claim 34, wherein the bead abrasive is one of a slag bead abrasive, a steel shot, or ceramic bead abrasive.

36. The blasting abrasive of claim 34, wherein the bead abrasive is glass bead abrasive.

37. The blasting abrasive of claim 34, wherein the bead abrasive in a concentration in a range of 0.5 wt. % to 20 wt. %.

38. The blasting abrasive of claim 34, wherein the bead abrasive is a glass bead abrasive and the glass bead abrasive is in a concentration in a range of 1 wt. % to 12 wt. %.

39. A mineral slag blasting abrasive, comprising:
at least one mineral slag abrasive, and
a bead abrasive, wherein the bead abrasive is less than 70 wt. % of the weight of the blasting abrasive.

40. The mineral slag blasting abrasive of claim 39, wherein the concentration of bead abrasive in the blasting abrasive is in the range of 0.1 wt. % to 50 wt. %.

41. The mineral slag blasting abrasive of claim 39, wherein the concentration of bead abrasive in the blasting abrasive is in the range of 0.1 wt. % to 20 wt. %.

42. The mineral slag blasting abrasive of claim 39, wherein the concentration of bead abrasive in the blasting abrasive is in the range of 0.5 wt. % to 12 wt. %.

43. The mineral slag blasting abrasive of claim 39, wherein the bead abrasive comprises one of a glass bead, a ceramic bead, a steel shot, polymer bead, or combinations thereof.

44. The mineral slag blasting abrasive of claim 39, wherein the mineral slag abrasive comprises one of nickel slag, coal slag, copper slag, iron slag, steel slag, platinum slag, or combinations thereof.

45. A naturally occurring minerals and mineral sands blasting abrasive, comprising:
at least one naturally occurring minerals and mineral sands abrasive, and
a bead abrasive, wherein the bead abrasive is less than 70 wt. % of the weight of the blasting abrasive.

46. The naturally occurring minerals and mineral sands blasting abrasive of claim 39, wherein the concentration of bead abrasive in the naturally occurring minerals and mineral sands blasting abrasive is in the range of 0.1 wt. % to 50 wt. %.

47. The naturally occurring minerals and mineral sands blasting abrasive of claim 39, wherein the concentration of bead abrasive in the naturally occurring minerals and mineral sands blasting abrasive is in the range of 0.1 wt. % to 20 wt. %.

48. The naturally occurring minerals and mineral sands blasting abrasive of claim 39, wherein the concentration of bead abrasive in the naturally occurring minerals and mineral sands blasting abrasive is in the range of 0.5 wt. % to 12 wt. %.

49. The naturally occurring minerals and mineral sands blasting abrasive of claim 39, wherein the bead abrasive comprises one of a glass bead, a ceramic bead, a steel shot, polymer bead, or combinations thereof.

50. The naturally occurring minerals and mineral sands blasting abrasive of claim 39, wherein the naturally occurring minerals and mineral sands abrasive comprises one of garnet, alluvial garnet, staurolite, or combinations thereof.

51. A crushed glass blasting abrasive, comprising:
at least one crushed glass abrasive, and
a bead abrasive, wherein the bead abrasive is less than 70 wt. % of the weight of the blasting abrasive.

52. The crushed glass blasting abrasive of claim 51, wherein the concentration of bead abrasive in the crushed glass blasting abrasive is in the range of 0.1 wt. % to 50 wt. %.

53. The crushed glass blasting abrasive of claim 51, wherein the concentration of bead abrasive in the crushed glass is in the range of 0.1 wt. % to 20 wt. %.

54. The crushed glass blasting abrasive of claim 51, wherein the concentration of bead abrasive in the crushed glass blasting abrasive is in the range of 0.5 wt. % to 12 wt. %.

55. The crushed glass blasting abrasive of claim 51, wherein the bead abrasive comprises one of a glass bead, a ceramic bead, a steel shot, polymer bead, or combinations thereof.

56. The crushed glass blasting abrasive of claim 51, wherein the crushed glass comprises one of recycled crushed glass, high density crushed glass, glass produced from concrete, or combinations thereof.

57. The blasting abrasive of claim 1, wherein the SAB abrasive has an SAB average particle size, the bead abrasive has a bead average particle size and the bead average particle size is less than the SAB average particle size.

58. The mineral slag blasting abrasive of claim 39, wherein the mineral slag abrasive has an SAB average particle size, the bead abrasive has a bead average particle size and the bead average particle size is less than the SAB average particle size.

59. The naturally occurring minerals and mineral sands blasting abrasive of claim 45, wherein the naturally occurring minerals and mineral sands abrasive has an SAB average particle size, the bead abrasive has a bead average particle size and the bead average particle size is less than the SAB average particle size.

60. The crushed glass blasting abrasive of claim 45, wherein the crushed glass abrasive has an SAB average particle size, the bead abrasive has a bead average particle size and the bead average particle size is less than the SAB average particle size.
